(19) United States
(12) Patent Application Publication
(10) Pub. No.: US 2011/0034322 A1
(43) Pub. Date: Feb. 10, 2011

(54) METHOD FOR PRODUCING A FRACTURE-RESISTANT CATALYST FOR DESULPHURIZING GASES

(75) Inventors: Frank GROSSMANN, Munich (DE); Oliver WEGNER, Bruckmuehl (DE); Peter ROEGER, Grosskarolinenfeld (DE)

Correspondence Address: RATNERPRESTIA, P.O. BOX 980, VALLEY FORGE, PA, 19482, US

(73) Assignee: SUD-CHEMIE AG, Munich (DE)

(21) Appl. No.: 12/850,895

(22) Filed: Aug. 5, 2010

(30) Foreign Application Priority Data
Aug. 5, 2009 (DE) 10 2009 036 203.7

(51) Int. Cl. B01J 37/10; B01J 21/16; B01J 23/887

(52) U.S. Cl. 502/84; 502/307

(57) ABSTRACT

A method for producing a catalytically active absorber for desulphurizing hydrocarbon streams by mixing a thermally decomposable copper source, a thermally decomposable molybdenum source, zinc oxide, and water, heating the mixture to decompose the copper and molybdenum sources to produce zinc oxide loaded with copper and molybdenum, and calcining the zinc oxide, wherein the zinc oxide has a specific surface area of more than 20 m²/g and an average particle size D₅₀ in the range of from 7 to 60 μm.

### CROSS-REFERENCE TO RELATED APPLICATION

This application claims priority benefit of German application number DE 10 2009 036 203.7, filed Aug. 5, 2009, the content of such application being incorporated herein by reference.

### FIELD OF THE INVENTION

The invention relates to a method for producing a catalyst for desulphurizing hydrocarbon streams.

### BACKGROUND OF THE INVENTION

Most catalysts, in particular if they contain transition metals, are poisoned by organic sulphur compounds and thereby lose their activity. In many hydrocarbon conversion processes, such as for example the reforming of methane or other hydrocarbons, for example when producing synthesis gas for methanol synthesis, or for producing energy from methanol in fuel cells, it is therefore necessary to lower the sulphur content in the hydrocarbon stream into the ppb range.

The separation of the organic sulphur compounds from the hydrocarbon stream generally comprises two steps which are carried out in separate reactors. In the first reactor, the organic sulphur compounds are reduced to hydrogen sulphide. For this, the hydrocarbon stream is passed, adding a suitable reducing agent such as gaseous hydrogen, over a catalyst which typically contains cobalt and molybdenum or nickel and molybdenum. Sulphurous compounds contained in the gas, such as e.g. thiophenes, are thereby reduced accompanied by production of hydrogen sulphide. Typical catalysts for hydrodesulphurization are produced by impregnating supports such as aluminium oxide with molybdenum or tungsten salts to which promoters such as cobalt or nickel have been added. Customary catalysts for hydrodesulphurization are for example mixtures of cobalt and molybdenum compounds on aluminium oxide, nickel on aluminium oxide, or mixtures of cobalt and molybdates to which nickel has been added as promoter and which are supported on aluminium oxide.

After reduction, the gas stream is fed to a second reactor in which the hydrogen sulphide originally contained in the gas or produced during the reduction of organic sulphur compounds is absorbed on a suitable absorber. For this, the hydrocarbon stream usually passes through the bed of a solid absorber, for example a zinc oxide absorber bed.

Catalytically active absorbers are also known in which the hydrogenation of the organic sulphur compound is carried out directly by the absorber. For this, catalytically active metal compounds are applied directly to the sulphur absorber, typically zinc oxide. This has the advantage that only one reactor is required for desulphurizing the hydrocarbon stream. Typically, molybdenum or tungsten compounds to which promoters such as cobalt and nickel have been added are used as catalytically active metals.

In order to make the desulphurization of the hydrocarbon stream as complete as possible, such catalytically active absorbers should have a high hydrogenation activity vis-à-vis sulphurous organic compounds, such as for example thiophene or thioethers. Furthermore, such a catalyst should have as small as possible a decrease in its hydrogenation activity over its lifetime. The catalytically active absorber should furthermore display a high affinity for sulphur to make it possible, even with a relatively small quantity of absorber, to reduce the sulphur content to the lowest possible level. Further, such a catalytically active absorber should have a high sulphur absorption capacity to make it possible for catalysts to have long service lives, i.e. the longest possible intervals before being replaced by a new, fresh, catalytically active absorber.

### DESCRIPTION OF THE RELATED ART

In GB 1,011,001, a catalyst for desulphurizing organic compounds is described, wherein the catalyst comprises a support which consists of finely-dispersed zinc oxide and a compound which contains hexavalent molybdenum as well as oxygen. According to a preferred embodiment, the catalyst can comprise a promoter such as copper oxide. To produce the catalyst, zinc oxide is reacted in the presence of water with a compound which reacts with zinc oxide to form zinc carbonate. The mixture is shaped, dried and calcined in order to obtain a finely-dispersed zinc oxide. Before, during or after the production of the zinc oxide, a compound is added which contains hexavalent molybdenum and oxygen. For this, the zinc oxide can be impregnated for example with an aqueous solution of ammonium molybdate. If appropriate, the impregnation must be repeated several times in order to be able to apply sufficient quantities of molybdate to the support. According to another embodiment, the catalyst is produced by kneading a mixture of zinc oxide, water and ammonium carbonate, and the desired quantity of zinc molybdate or molybdic acid as well as optionally copper carbonate is added to the material. In the examples, the production of a copper/zinc/molybdenum catalyst is described, wherein zinc oxide, ammonium hydrogen carbonate and water are kneaded. Molybdic acid and basic copper carbonate are added to this mixture. The material is shaped into shaped bodies, dried and then calcined at 300 to 350° C. In this method, the copper and molybdenum salts are thus first converted into their oxide form by calcining the dry shaped body.

In DE 10 2005 004 429 A1, a method for producing a catalyst for desulphurizing hydrocarbon streams is described with the steps:
a) producing a mixture containing:
   a copper source, such as copper carbonate, copper hydroxy carbonate, copper hydroxide, copper nitrate, or salts of organic acids such as copper formate, copper oxalate or copper tartrate;
   a molybdenum source, such as ammonium molybdate, molybdic acid or molybdenum salts of organic acids;
   a zinc source, such as zinc carbonate, zinc hydroxide, zinc hydroxy carbonate or zinc salts of organic acids such as zinc formate, zinc acetate or zinc oxalate, or zinc oxide; and
   water.
b) producing a precipitate from the mixture;
c) separating the precipitate from the mixture;
d) drying the precipitate.

In one of the examples, a suspension is produced from an ammonium hydrogen carbonate solution, a solution of Cu(NH₃)CO₃, ZnO and (NH₄)₆Mo₇O₂₄.4H₂O. A zinc oxide with a small surface area in the range of from approximately 5 m²/g can be used as zinc source. However, a zinc oxide with a high specific surface area can also be used, which preferably has a specific surface area of more than 20 m²/g, preferably more than 50 m²/g. Such a zinc oxide can be obtained for example by adding alkali hydroxides and/or alkali carbonates to water-soluble zinc salts, wherein the precipitate can be calcined directly after the separation and drying.

The mixture of zinc oxide, copper source and molybdenum source is preferably finely ground before the production of the precipitate, i.e. before the decomposition of the copper as well as the molybdenum source. The grinding is preferably continued until the average particle size in the mixture is less than 100 μm, preferably less than 5 μm, in particular less than 1 μm. The copper and molybdenum compounds are preferably decomposed by passing steam through the suspension. The suspension is dried in the countercurrent by spray-drying. The powder obtained is mixed with 2% graphite as lubricant, shaped into tablets with a tablet press and then calcined.

In DE 10 2005 004 368 A1, a catalyst is described which comprises a hydrogenating component as well as an absorption component. The hydrogenating component comprises at least one element which is selected from the group of copper, molybdenum, tungsten, iron, nickel and cobalt. The absorption component consists of zinc oxide. The catalyst preferably displays a total pore volume between 30 and 500 mm³/g and a specific surface area of more than 5 m²/g, preferably more than 50 m²/g. In one of the examples, a suspension is produced from an ammonium hydrogen carbonate solution, a solution of Cu(NH₃)CO₃, ZnO and (NH₄)₆Mo₇O₂₄.4H₂O. The zinc oxide used is not specified in more detail. To decompose the copper and molybdenum compounds, steam is passed through the suspension. The suspension is dried in the countercurrent by spray-drying. The powder obtained is mixed with 2% graphite as lubricant, shaped into tablets with a tablet press and then calcined.

The catalytically active absorber is consumed during the desulphurization of the hydrocarbon stream. If the absorption capacity of the catalytically active absorber is exhausted, the latter must be removed from the reactor and reworked. The reactor is then filled with new catalytically active absorber.

During the charging of the reactor, a packing of the catalyst bodies is to be produced that produces the smallest possible drop in pressure in the gas stream. During the packing of the catalyst as well as during its transportation from the production site to the reactor as well as during the filling of the reactor, the catalyst bodies of the catalytically active absorber are exposed to strong mechanical stresses. It is therefore virtually unavoidable that some of the catalyst bodies break. In the process, smaller catalyst bodies, as well as dust, form. After transportation of the catalytically active absorber to the reactor, this catalyst breakage must be screened out, as otherwise the catalyst body will continue to be packed too tightly in the reactor, resulting in a large drop in pressure of the carbon stream passed through the catalyst bed. However, it is not thereby possible to prevent further catalyst bodies from breaking when filling the reactor, thus resulting in an uneven catalyst layering. In order to increase the stability of the catalyst bodies, a binder, for example cement, can be added to the catalyst bodies. However, as a binder behaves inertly vis-à-vis sulphur compounds, it is attempted to keep the proportion of binder as low as possible. A compromise is therefore always necessary, with the result that when a binder is used it is not always possible to completely prevent the catalyst bodies from breaking under mechanical stress.

### DESCRIPTION OF THE INVENTION

An object of the invention was therefore to provide a method for producing a catalyst for desulphurizing hydrocarbon streams, with which catalyst bodies can be produced which have a very high fracture resistance and dimensional stability, with the result that they do not break even when subjected to higher mechanical loads, wherein a high sulphur absorption capacity is simultaneously achieved.

This object is achieved with a method with the features of claim 1. Advantageous embodiments of the method according to aspects of the invention are a subject of the dependent claims.

Surprisingly it was found that, by using a specific zinc oxide which has a high specific surface area as well as a particle size within a particular range, catalyst bodies can be produced which have an improved fracture resistance. In particular when charging a reactor with the catalyst bodies less catalyst breakage therefore results, with the result that the packing of the reactor produces a smaller drop in pressure and the reactor can thus be operated in a more cost-favourable manner. The zinc oxide acts as sulphur absorber, with the result that when the stability is increased a compromise at the expense of the sulphur absorption capacity of the catalyst is not required. The catalyst displays both a high hydrogenation activity for the hydrogenation of organic sulphur compounds and a high affinity as well as a high absorption capacity for sulphur, with the result that the sulphur content in the hydrocarbon stream can be reduced into the ppb range (ppb=parts per billion).

According to aspects of the invention, a method for producing a catalyst for desulphurizing hydrocarbon streams is provided, wherein:
a) a mixture is produced from:
   a thermally decomposable copper source;
   a thermally decomposable molybdenum source;
   zinc oxide; and
   water;
b) the mixture is heated to a temperature at which the thermally decomposable copper source and the thermally decomposable molybdenum source decompose, with the result that a zinc oxide loaded with copper and molybdenum compounds is obtained; and
c) calcining the zinc oxide loaded with copper and molybdenum compounds, wherein a sulphur-absorbing catalyst is obtained.

It is provided according to aspects of the invention that there is used as zinc oxide a zinc oxide with a specific surface area of more than 20 m²/g and an average particle size D₅₀ in the range of from 7 to 60 μm.

In the method according to aspects of the invention a mixture is firstly produced from a thermally decomposable copper source, a thermally decomposable molybdenum source, zinc oxide and water. For this, an aqueous solution of the thermally decomposable copper source and the thermally decomposable molybdenum source is preferably produced. The copper source and the molybdenum source can be dissolved jointly in water. However, it is also possible to produce two solutions, wherein one solution contains the copper source and the other solution the molybdenum source. The aqueous solution or the aqueous solutions are then mixed with the zinc oxide. The mixing can take place in any manner desired per se. The zinc oxide can be added to the aqueous solution, or else the aqueous solution of the copper or molybdenum compound added to the zinc oxide. The procedure when producing the mixture is preferably such that a uniform distribution of the copper or molybdenum compound on the zinc oxide is achieved. For this, for example a suspension of the zinc oxide in the aqueous solution of the copper and molybdenum compound can be produced which has a sufficiently low viscosity, with the result that it can be stirred without difficulty. However, it is also possible to work with only a small quantity of water and to homogenize the plastic material by kneading.

By a thermally decomposable copper compound or a thermally decomposable molybdenum compound is meant a compound which, upon heating in water, decomposes into a different copper or molybdenum compound, preferably into a water-insoluble copper or molybdenum compound. For this, the thermally decomposable copper or molybdenum compound preferably comprises anions or cations which can be expelled from the aqueous solution by passing hot steam or an inert gas through an aqueous solution of the copper or molybdenum compound. Such anions or cations are for example carbonate or hydrogen carbonate ions and ammonium ions.

During thermal decomposition, less defined compounds, such as basic oxides, hydroxocarbonates etc., form. These undefined compounds can be converted into copper or molybdenum oxide in a calcining step.

The thermally decomposable copper compound is preferably chosen such that during thermal decomposition no products form which disrupt the production of the catalyst, in particular reduce its activity, for example fluoride ions. The thermally decomposable copper compound is preferably chosen such that during thermal decomposition gaseous or water-soluble compounds form which can be expelled from the aqueous mixture, preferably by heating or passing through inert gases, such as steam.

Suitable thermally decomposable copper compounds which—optionally after an additional calcining step—can be converted into copper oxide are for example copper carbonate, copper hydroxocarbonates, copper hydroxide, copper nitrate and salts of organic acids, such as copper formate, copper oxalate or copper tartrate. According to a preferred embodiment, amine complexes of copper are used, in particular cupric tetramine complexes, which comprise volatile anions, for example the previously named anions.

Cupric tetramine carbonate Cu(NH₃)₄CO₃ is particularly preferably used as thermally decomposable copper source.

The thermally decomposable molybdenum compound is likewise preferably chosen such that during thermal decomposition gaseous or water-soluble compounds are split off which can preferably be expelled from the solvent, for example by heating or passing through inert gases, such as for example steam.

Suitable molybdenum compounds which—optionally after an additional calcining step—can be converted into molybdenum oxide are for example molybdates with volatile cations, such as ammonium molybdate, molybdic acid or molybdenum salts of organic acids, such as molybdenum acetate.

An ammonium molybdate, for example (NH₄)₆Mo₇O₂₄.4H₂O, is particularly preferably used as thermally decomposable molybdenum compound.

In addition to water, further solvents such as glycol, alcohols, dimethylformamide or dimethyl sulphoxide can also be added. These can act for example as solubilizers. Preferably, only water is used as solvent.

In the method according to aspects of the invention, a zinc oxide with a high specific surface area as well as a particle size within a specific range is used.

The zinc oxide has a specific surface area of more than 20 m²/g, preferably more than 25 m²/g, according to a further embodiment more than 30 m²/g, according to yet another embodiment more than 40 m²/g and according to a further embodiment has a specific surface area of more than 46 m²/g. It is advantageous per se to use a zinc oxide which has as high a specific surface area as possible. It is provided for technical reasons according to one embodiment that the zinc oxide has a specific surface area of less than 70 m²/g, according to a further embodiment less than 60 m²/g, and according to yet another embodiment less than 55 m²/g. The specific surface area is measured according to BET in accordance with DIN 66131.

The zinc oxide further has an average particle size D₅₀ in the range of from 7 to 60 μm. According to one embodiment, the zinc oxide has a particle size D₅₀ of less than 50 μm, according to a further embodiment less than 40 μm. According to a further embodiment, the particle size D₅₀ of the zinc oxide is greater than 8 μm, according to a further embodiment greater than 9 μm and according to yet another embodiment greater than 10 μm. The D₅₀ value denotes a value at which half of the particles have a larger or a smaller particle diameter respectively. In the case of irregularly shaped zinc oxide particles the average particle diameter is understood as particle size within the meaning of the invention. To determine the particle size, methods are therefore used in which the particle diameter of an individual particle is averaged over the total number of particles, for example laser diffractometry.

The determination of the particle size distribution by laser diffractometry is performed according to ISO 13320-1. The evaluation of the data is performed based on assumptions relating to Fraunhofer.

The particle size distribution preferably is monomodal. The ratio D₁₀/D₅₀ preferably is within a range of 0.2 to 0.5, particularly preferred 0.22 to 0.45. The ratio D₉₀/D₅₀ preferably is within a range of 1.5 to 3.5, particularly preferred within a range of 1.7 to 2.7. D₁₀ designates a value, at which 10% of the particles have a smaller diameter than D₁₀. Accordingly, D₉₀ designates a value at which 90% of the particles have a smaller diameter than D₉₀. The D₁₀-, D₅₀- and D₉₀-values refer to the volume of the dry powdering sample.

It is provided according to one embodiment that the zinc oxide has a pore volume of more than 200 mm³/g, according to a further embodiment more than 220 mm³/g. It is provided according to one embodiment that the pore volume is less than 300 mm³/g, according to a further embodiment less than 250 mm³/g.

The mixture is heated to a temperature at which the thermally decomposable copper source and the thermally decomposable molybdenum source decompose, with the result that a zinc oxide loaded with copper and molybdenum compounds is obtained. For this, the mixture is preferably treated with hot steam, with the result that the volatile anions and cations contained in the thermally decomposable copper compound or in the thermally decomposable molybdenum compound are expelled from the mixture and the copper or molybdenum compound is converted into a water-insoluble compound. The zinc oxide loaded with copper and molybdenum compounds subsequently has a relatively unspecific composition, as the expulsion of the steam-volatile anions and cations does not result in defined copper and molybdenum compounds, but in mixtures of hydroxides, basic oxides and oxides, wherein for example small quantities of carbonate ions or ammonium ions can also be contained.

The thermal decomposition is preferably carried out until essentially no further volatile ions, in particular no ammonium ions, are contained in the zinc oxide loaded with copper and molybdenum compounds. The ammonium ion concentration of the zinc oxide loaded with copper and molybdenum ions is preferably reduced to a value of less than 5 wt.-%, preferably less than 1 wt.-% ammonium ions, calculated as NH₄OH and relative to the moist material (moisture content (LOD at 120° C.): 20-21%) after thermal decomposition. This has the advantage that during the further processing no ammonia escapes from the zinc oxide loaded with copper and molybdenum compounds. The zinc oxide loaded with copper and molybdenum compounds can therefore be more easily processed because, in the absence of ammonia emissions, no further specific protection measures are required.

The zinc oxide loaded with copper and molybdenum compounds can then also be dried and optionally comminuted. The zinc oxide loaded with copper and molybdenum compounds is then also calcined, wherein the molybdenum and copper compounds are converted into the corresponding oxides. The calcining is preferably carried out in the presence of air. The calcining is preferably carried out at a temperature of more than 200° C., preferably more than 250° C., particularly preferably more than 300° C. According to one embodiment, the calcining temperature is chosen to be less than 600° C., according to a further embodiment less than 550° C. and according to yet another embodiment less than 500° C. The duration of the calcining is chosen such that at the chosen temperature the conversion into the oxides is as complete as possible. A duration of at least 1 hour, preferably at least 2 hours, is preferably chosen for the calcining. According to one embodiment, the calcining duration is chosen to be less than 10 hours, according to a further embodiment less than 5 hours.

Without wishing to be tied to this theory, the inventors assume that the shape or the structure of the particles of the zinc oxide used is essential to increase the stability of the catalyst bodies.

When producing the mixture the zinc oxide is therefore preferably used in substance, i.e. a zinc oxide is used which already displays the parameters described above. As a result, it is possible to set very precisely the particle size distribution and the specific surface area of the zinc oxide. This zinc oxide defined by its physical parameters is then mixed with the thermally decomposable copper source, the thermally decomposable molybdenum source and water in order to obtain the mixture.

In theory it would also be possible to use a zinc oxide which has a specific surface area of less than 20 m²/g, and to convert this zinc oxide into a zinc oxide with a high surface area in the course of the synthesis. In this embodiment, however, it is possible only with difficulty to set the particle size of the zinc oxide in the above-named range. Therefore, if a zinc oxide with a lower specific surface area is to be used, the procedure is preferably that the zinc oxide with a low surface area is firstly converted into a zinc oxide with a high specific surface area. For this, the zinc oxide can be treated for example with an aqueous solution of sodium carbonate or ammonium bicarbonate. The treated zinc oxide is separated off from the aqueous phase, optionally washed and calcined. The thus-produced zinc oxide with a high specific surface area can then be used to produce the mixture after setting the particle size distribution.

As already stated above, the shape and the physical properties of the zinc oxide are essential to increase the stability of the catalysts or catalyst bodies obtainable with the method according to aspects of the invention.

The production of the mixture is preferably carried out under conditions such that the particle size of the zinc oxide does not change during the production of the catalyst.

It is therefore provided according to one embodiment that the pH of the mixture is adjusted in a range of from 7 to 11. Under these conditions, a reaction of the zinc oxide with hydroxide ions or protons can be largely suppressed, with the result that the physical properties of the zinc oxide are preserved in the mixture. To adjust the pH, for example sodium hydrogen carbonate can be added to the mixture.

It is provided according to a further preferred embodiment that no ammonium bicarbonate is added to the mixture. Admittedly, the specific surface area of the zinc oxide used increases in the presence of ammonium bicarbonate, which is advantageous per se. However, the size of the zinc oxide particles changes at the same time. A change in the particle size, however, influences the fracture resistance of the catalyst and is therefore preferably avoided. By avoiding an addition of ammonium bicarbonate, the physical properties of the zinc oxide in the mixture do not change.

The catalyst produced with the method according to aspects of the invention acts both as a hydrogenation catalyst and as a sulphur absorber. As already stated above, the use of a specific zinc oxide characterized by its physical properties makes it possible to increase the stability of the bodies of the catalyst obtained with the method according to aspects of the invention without the proportion of binder also having to be increased. In order to guarantee a sufficiently long life of the catalyst, the proportion of zinc oxide in the finished catalyst is preferably chosen relatively high. At a given stability of the catalyst bodies, the proportion of binder can also be reduced accordingly by the method according to aspects of the invention. This ultimately means a lengthening of the service life of a reactor that is filled with the catalytic absorber, or the reactor can be designed smaller if there are defined requirements as regards the sulphur quantity to be absorbed. This is of interest for example for mobile applications, such as e.g. transportable fuel cells.

The quantity of copper source, molybdenum source and zinc oxide is particularly preferably chosen such that the catalyst has a copper content in the range of from 0.1 to 20 wt.-%, preferably 0.5 to 10 wt.-%, particularly preferably 0.8 to 5 wt.-%, a molybdenum content in the range of from 0.1 to 20 wt.-%, preferably 0.5 to 10 wt.-%, particularly preferably 0.8 to 5 wt.-%, and a zinc content in the range of from 60 to 99.8 wt.-%, preferably 80 to 99 wt.-%, particularly preferably 90 to 98 wt.-%, in each case relative to the weight of the binder-free shaped body or catalyst (no loss on ignition at 600° C.) and calculated as oxides of the metals (CuO, MoO₃, ZnO).

The aqueous solutions used in the production of the catalyst are accordingly set such that a catalyst with the above composition is obtained.

According to a first embodiment, the method for producing the mixture is that the volume of the solutions of the thermally decomposable copper source as well as of the thermally decomposable molybdenum source is chosen such that the quantity of liquid added to the zinc oxide is smaller than the pore volume of the zinc oxide. This method is also called “incipient wetness”. In this method, a very uniform distribution of the copper and molybdenum compounds on the zinc oxide is achieved, without substantial quantities of water having to be separated off again in a later production step. A plastic material is obtained which can be processed by kneading.

According to a further embodiment, the mixture is produced in the form of a suspension. In this embodiment, aqueous solutions can therefore be used which have a lower concentration of copper or molybdenum compounds. The concentration of the aqueous solution of the thermally decomposable copper source is preferably chosen such that the concentration of the thermally decomposable copper source in the aqueous suspension is in the range of from 0.01 to 0.2 mol/l, preferably in the range of from 0.015 to 0.1 mol/l, particularly preferably in the range of from 0.02 to 0.075 mol/l, calculated as Cu²⁺.

The concentration of the aqueous solution of the thermally decomposable molybdenum source is preferably chosen such that the concentration of the thermally decomposable molybdenum source in the aqueous suspension is in the range of from 0.01 to 0.2 mol/l, preferably in the range of from 0.015 to 0.1 mol/l, particularly preferably in the range of from 0.02 to 0.075 mol/l, relative to Mo.

The quantity of zinc oxide in the aqueous suspension is preferably chosen in the range of less than 600 g/l, as otherwise the viscosity of the mixture may increase too sharply. In order to prevent the quantity of solvent from increasing excessively, the zinc oxide content is preferably chosen greater than 50 g/l, particularly preferably chosen in the range of from 100 to 200 g/l.

The mixture is preferably produced at room temperature in order to avoid a premature release of ammonia or other compounds. The mixture is preferably produced at temperatures in the range of from 15 to 60° C., preferably 20 to 50° C. The mixture is preferably agitated in order to achieve a uniform distribution of the copper source and the molybdenum source on the zinc oxide. For this, for example the mixture can be kneaded or stirred. Customary devices can be used for this.

The procedure for the thermal decomposition of the copper source as well as of the molybdenum source is preferably that the mixture is treated with hot steam. For this, for example hot steam can be passed through the aqueous suspension of the starting compounds. The steam can be introduced through customary devices. For example, an annular inlet can be provided in the reaction vessel, which is provided with openings through which the steam is passed into the mixture. The compounds released during the thermal decomposition, for example carbon dioxide, ammonia or other released compounds are simultaneously expelled from the mixture by the steam. The steam preferably has a temperature in the range of from 120 to 180° C., preferably 140 to 160° C., measured at the exit point of the steam.

If the mixture contains only a small quantity of water, the mixture is preferably agitated, for example in a kneader, during the decomposition of the thermally decomposable copper source as well as of the thermally decomposable molybdenum source. Steam is preferably introduced during decomposition so that volatile compounds, preferably ammonia and carbon dioxide, are removed from the mixture. For decomposition, the mixture is preferably heated to a temperature in the range of from 80 to 140° C., preferably 95 to 120° C.

If the mixture contains ammonium ions, the decomposition is preferably continued until the ammonium concentration of the zinc oxide loaded with copper and molybdenum ions has been reduced to a value of less than 5 wt.-%, preferably less than 1 wt.-% ammonium ions, calculated as NH₄OH and relative to the moist material (moisture content (LOD at 120° C.): 20-21%) after thermal decomposition.

The thermal decomposition can optionally also be followed by an aging step. For this, the mixture can be kept at a specific temperature after decomposition for preferably at least 1 hour, further preferably at least 10 hours. At longer aging times, no further substantial change in the catalyst properties is observed. The aging is preferably ended after at most 100 hours, preferably at most 40 hours. The aging is preferably carried out at a temperature in the range of from 15 to 70° C., preferably at room temperature.

The mixture obtained after thermal decomposition can then be dried. For this, for example some of the water can be separated off by decanting or filtration and the remaining moist solid then further dried. If substantial lumps of the mixture form during drying, the mixture can also further be comminuted. Customary grinders can be used for this.

The separation of the water from the mixture and the comminution of the dry mixture can also be carried out by drying the mixture by spray-drying. The spray-drying can be carried out directly from the suspension obtained during thermal decomposition. If the mixture contains large quantities of water, it is possible to remove some of the water before spray-drying, for example by decanting-off, filtration or distilling-off. The solids content of the suspension is preferably 10 to 30 wt.-, particularly preferably 20 to 25 wt.-%, before spray-drying. The spray-drying can be carried out in customary devices, wherein customary conditions are maintained.

After thermal decomposition, the zinc oxide loaded with copper and molybdenum compounds is preferably shaped into catalyst bodies. Customary devices, for example extruders, tablet presses or granulating devices, can be used for this.

According to one embodiment, a binder can be added to the zinc oxide loaded with copper and molybdenum compounds, obtained after thermal decomposition. The addition of the binder is thus carried out after thermal decomposition of the copper and molybdenum compounds and before shaping. Suitable binders are for example talc, aluminium oxide, as well as pseudo-boehmite, aluminium silicates, zirconium dioxide or cement. Cement is preferably used as binder.

The proportion of binder is based on the desired strength of the shaped bodies. The quantity of binder is chosen as small as possible in order to minimize loss in activity of the desulphurizing catalyst. The proportion of binder (relative to the dry substance content, measured via the LOI measurement (loss on ignition) at 1000° C.) is preferably chosen in the range of from 0.1 wt.-% to 20 wt.-%, particularly preferably of from 1 wt.-% to 10 wt.-%.

A lubricant can also further be added to the zinc oxide loaded with copper and molybdenum compound before shaping. Suitable lubricants are for example aluminium stearate, polyvinyl alcohol, stearic acid or graphite. Graphite is preferably used as lubricant.

The quantity of lubricant is chosen as small as possible. The proportion of binder (relative to the dry substance content, measured via the LOI measurement (loss on ignition) at 1000° C.) is preferably chosen in the range of from 0.05 wt.-% to 10 wt.-%, particularly preferably 1 wt.-% to 5.0 wt.-%. Lubricants are added for example when the shaping takes place using a tablet press. The lubricant is removed again during calcining.

If cement is used as binder, the shaped bodies are preferably also treated with steam after shaping in order to accelerate curing. Such a steam curing is carried out in customary devices. The duration of the steam curing is based on the quantity of cement added and the conditions under which the steam curing is carried out.

After shaping, calcining is then also carried out. The conditions described above are used. The calcining is carried out in customary ovens. For example rotary kilns or belt kilns are suitable.

The catalyst obtained with the method according to aspects of the invention has very good properties in the desulphurization of hydrocarbon streams. It makes possible the simultaneous reduction of sulphurous organic compounds and the absorption of the hydrogen sulphide formed. The sulphur is bound by the zinc oxide to the hydrogenation-active metal in the immediate vicinity. For the hydrogenation-catalytic activity, at least portions of the molybdenum must be present in the form of the sulphide. If the catalyst is operated over a prolonged period in a hydrocarbon stream which is free of sulphurous organic compounds, the molybdenum compound is depleted of sulphur and is thus deactivated. However, because the sulphur remains bound by zinc oxide in the catalyst obtained with the method according to aspects of the invention, the sulphur is available, with the result that the catalyst becomes active again immediately if hydrocarbon streams which contain sulphurous organic compounds are passed through anew.

The catalyst preferably has a specific surface area, measured by the BET method, of less than 60 m²/g, preferably less than 50 m²/g, preferably more than 20 m²/g, particularly preferably more than 25 m²/g.

The desulphurizing catalyst obtained with the method according to aspects of the invention can be used in customary manner for desulphurizing hydrocarbon streams. Customary reaction conditions are applied. The reaction can be carried out for example in a temperature range of from 260 to 550° C., at a hydrocarbon partial pressure of from 0.3 to 4 bar and an LHSV (liquid hourly space velocity) in the range of from 0.1 to 20. For this, the catalyst is filled into a customary reactor. The diameter of the shaped bodies is preferably chosen in the range of from 0.1 to 7 mm, preferably in the range of from 0.5 to 5 mm. The length of the shaped bodies is preferably chosen in the range of from 0.5 to 30 mm, preferably in the range of from 0.8 to 25 mm, particularly preferably in the range of from 10 to 20 mm.

### BRIEF DESCRIPTION OF THE FIGURES

The invention is explained in more detail below using examples as well as with reference to the enclosed FIGURES. There are shown in:

FIG. 1 a flowchart of the production method;

FIG. 1 shows schematically the sequence for producing the catalyst according to aspects of the invention.

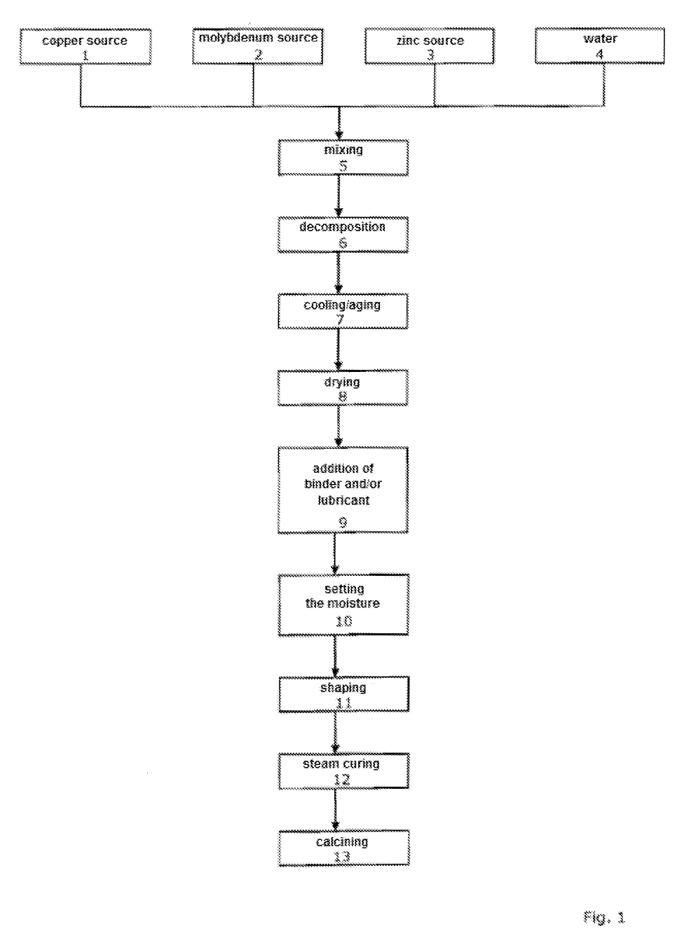

In a first step, a cupric tetramine carbonate solution 1 as thermally decomposable copper source, an ammoniumheptamolybdate solution 2 as thermally decomposable molybdenum source as well as zinc oxide 3 are mixed 5 with demineralized water 4, in order to obtain a mixture of the components in the form of an aqueous suspension. The pH is adjusted without adding ammonia water. To mix the starting materials, the aqueous suspension 5 is heated to a temperature in the range of from 25 to 50° C.

In the next step, the cupric tetramine carbonate as well as the ammoniumheptamolybdate are thermally decomposed. The temperature of the aqueous suspension increases locally to values of from approximately 50 to 103° C. During the decomposition of the thermally decomposable starting components, carbon dioxide as well as ammonia are released from the aqueous suspension. After thermal decomposition has ended, the suspension is cooled (7) to approximately room temperature. When the suspension is left to stand, the precipitate settles, with the result that the supernatant clear solution can be decanted off.

The remaining suspension is dried (8) and the obtained powder shaped into shaped bodies, adding a binder as well as a lubricant 9, for example cement and graphite. In order to adjust the moisture 10 of the mixture, demineralized water can be added to the mixture. The quantity of water added is approx. 20 wt.-%, relative to the solids content of the mixture. To produce pellets (11), the mixture is forced through a press and optionally cured by steam curing (12). The shaped bodies are then also calcined (13).

### Measurement Methods:

To measure the physical parameters, the following methods were used:

### Surface Area/Pore Volume:

The surface area was measured according to DIN 66131 using a fully automatic Micromeritics ASAP 2010-type nitrogen porosimeter. The pore volume was ascertained using the BJH method (E. P Barrett, L. G. Joyner, P. P. Haienda, J. Am. Chem. Soc. 73 (1951) 373). Pore volumes of specific pore size ranges are determined by totalling incremental pore volumes which are obtained from the evaluation of the adsorption isotherms according to BJH. The total pore volume according to the BJH method relates to pores with a diameter of from 1.7 to 300 nm.

### Pore Volume (Mercury Porosimetry)

Pore volume and pore-radius distribution were measured according to DIN 66133.

### Loss on Ignition:

Loss on ignition was measured according to DIN ISO 803/806.

### Bulk Density:

Bulk density was measured according to DIN ISO 903.

### Side Crushing Strength:

Side crushing strength was measured according to DIN EN 1094-5. The side crushing strength is obtained from the average of 100 measurements.

### Fracture Resistance in the Drop Test:

The sample (pellets 10 mm long) is subjected to a drop height of 3 metres. The fracture is measured beforehand and afterwards.

Approximately 100 g pellets are sorted into wholes (a), three-quarters (b), halves (c) and quarters (d) and weighed separately on the analytical balance.

### Calculation:

$$Total quantity 1 = a + b + c + d$$

$$Total breakage portion 1 ( \% ) = \frac{( Breakage portion b + c + d ( g ) * 100 )}{Total quantity 1}$$

The drop test must be carried out by two people. All of the sorted 100 g sample pellets are introduced into a 250-ml beaker. The drop tube is set at 3 metres. A 1000-ml beaker is positioned underneath the end of the pipe. The pellets are tipped vigorously into the upper end of the pipe and caught at the bottom.

The pellets are sorted again into wholes (e), three-quarters (f), halves (g) and quarters (h) and weighed separately on the analytical balance.

### Calculation:

$$Total quantity 2 = e + f + g + h$$

$$Total breakage portion 2 ( \% ) = \frac{( Breakage portion f + g + h ( g ) * 100 )}{Total quantity 2}$$

The breakage caused by the drop test is determined from the difference between total breakage portions 1 and 2 and serves as comparison variable in Table 1.

### Particle Size Distribution

The particle sizes were measured according to the laser diffraction method with a Fritsch Particle Sizer Analysette 22 Economy (Fritsch, DE) according to the manufacturer's instructions, including as regards the sample pre-treatment, according to ISO 13320-1: the sample is homogenized in deionized water without adding adjuvants and treated for 5 minutes with ultrasound. The D values given are relative to the sample volume.

### EXAMPLE 1

### According to the Invention

10 kg zinc oxide which had a specific surface area of 50 m²/g and an average particle size (D₅₀) of 11.64 μm was introduced into a kneader at room temperature and agitated dry for 10 minutes. A solution of 420 g ammoniumheptamolybdate in 2 l demineralized water was then added over 10 minutes, wherein the mixture was agitated continuously. The mixture was kneaded for a further 5 minutes and then added over a further 5 minutes to 1.42 kg of an aqueous solution of Cu(NH₃)₄CO₃ solution (C(Cu²⁺)=102.1 g/kg). A further 0.5 l demineralized water was then added over 2 minutes. For thermal decomposition of the copper and molybdenum compounds, superheated steam was then conducted into the kneader for 1 hour, wherein the mixture was agitated further. At the end of the decomposition, the steam feed was switched off and the kneader opened in order to expel moisture from the mixture accompanied by further agitation of the mixture and to cool the mixture. 200 g graphite as well as 300 g cement were added and the mixture kneaded to a homogeneous mixture for a further 10 minutes. The mixture was then set to a moisture of 20.5 wt.-% by adding demineralized water. The plastic material was shaped into pellets (418×10 mm) in a circular matrix press.

Some of the pellets were transferred to screens and the latter stored at 90° C. overnight in a desiccator together with a dish of demineralized water. For calcining, the pellets are transferred to a porcelain dish and heated to 120° C. in an oven at a heating rate of 1° C./min and kept at this temperature for 3 h. The temperature was then increased to 350° C. at a heating rate of 1° C./min and maintained for 5 h.

The pellets were cooled to room temperature and the side crushing strength as well as the fracture resistance during the drop test measured.

The values found are summarized with further physical parameters in Table 1.

### EXAMPLE 2

### Comparison Example

Example 1 was repeated, except that an LSA zinc oxide with an average particle size of 1.2 μm as well as a specific surface area of 4 m²/g was used as starting component. The side crushing strength as well as the fracture resistance in the drop test are also listed with further physical parameters in Table 1.

### EXAMPLE 3

### Comparison Example

Example 1 was repeated, except that an HSA zinc oxide with an average particle size of 6.5 μm as well as a specific surface area of 52 m²/g was used as starting component. The side crushing strength as well as the fracture resistance in the drop test are also listed with further physical parameters in Table 1.

### EXAMPLE 4

### Comparison Example

Example 1 was repeated, except that an LSA zinc oxide with an average particle size of 12.3 μm as well as a specific surface area of 6 m²/g was used as starting component. The side crushing strength as well as the fracture resistance in the drop test are also listed with further physical parameters in Table 1.

### EXAMPLE 5

### According to the Invention

Example 1 was repeated, except that an HSA zinc oxide with an average particle size of 37.1 μm as well as a specific surface area of 50 m²/g was used as starting component. The side crushing strength as well as the fracture resistance in the drop test are also listed with further physical parameters in Table 1.

### EXAMPLE 6

### Comparison Example

Example 1 was repeated, except that an HSA zinc oxide with an average particle size of 62.2 μm as well as a specific surface area of 45 m²/g was used as starting component. The side crushing strength as well as the fracture resistance in the drop test are also listed with further physical parameters in Table 1.

TABLE 1

| | | | Ex. 1 | Ex. 2 | Ex. 3 | Ex. 4 | Ex. 5 | Ex. 6 |
|---|---|---|---|---|---|---|---|---|
| ZnO type | | | HSA | LSA | HSA | LSA | HSA | HSA |
| | | | ZnO | ZnO | ZnO | ZnO | ZnO | ZnO |
| D₅₀ of the ZnO | μm | | 11.6 | 1.2 | 6.5 | 12.3 | 37.1 | 62.2 |
| BET of the ZnO | m²/g | | 50 | 4 | 52 | 6 | 50 | 45 |
| Pore volume of | (Hg) | | 232.6 | 6.4 | 240.1 | 4.7 | 235.3 | 198.1 |
| the ZnO | mm³/g | | | | | | | |
| Relative pore | % | | 0 | 0 | 1.4 | 0 | 2.6 | 4.5 |
| volume | 7500-857 | nm | | | | | | |
| | 875-40 | nm | 24.01 | 87.3 | 27.5 | 83.4 | 30.4 | 25.4 |
| | 40-7 | nm | 70.39 | 7.22 | 64.3 | 10.1 | 62.1 | 67.7 |
| | 7-3.7 | nm | 5.6 | 5.48 | 6.8 | 6.5 | 4.9 | 2.4 |
| BET of the | m²/g | | 35 | 64 | 36 | 54 | 33 | 30 |
| shaped body | | | | | | | | |
| Pore volume of | (N₂) | | 78 | 201 | 81 | 184 | 84 | 74 |
| the shaped body | mm³/g | | | | | | | |
| Breakage during | % | | 5 | 18 | 22 | 26 | 4 | 20 |
| drop test* | | | | | | | | |
| SDF-AV | N/10 | mm | 179 | 108 | 98 | 87 | 165 | 89 |
| SDF-min | N/10 | mm | 81 | 55 | 45 | 39 | 75 | 41 |
| SDF-max | N/10 | mm | 301 | 180 | 173 | 148 | 266 | 147 |

*Drop test with 10-mm long pellets and a drop height of 3 m

1. A method for producing a catalytically active absorber for desulphurizing hydrocarbon streams, comprising the steps of:
a) producing a mixture from:
a thermally decomposable copper source;
a thermally decomposable molybdenum source;
zinc oxide; and
water;
b) heating the mixture to a temperature at which the thermally decomposable copper source and the thermally decomposable molybdenum source decomposes, with the result that a zinc oxide loaded with copper and molybdenum compounds is obtained; and
c) calcining the zinc oxide loaded with copper and molybdenum compounds, wherein the catalytically active adsorber is obtained;
wherein there is used as zinc oxide a zinc oxide with a specific surface area of more than 20 m²/g and an average particle size D₅₀ in the range of from 7 to 60 μm.

2. The method according to claim 1, wherein the thermally decomposable copper source and the thermally decomposable molybdenum source are decomposed by treating the mixture with steam.

3. The method according to claim 1, wherein the zinc oxide loaded with copper and molybdenum compounds is shaped into shaped bodies.

4. The method according to claim 2, wherein the zinc oxide loaded with copper and molybdenum compounds is shaped into shaped bodies.

5. The method according to claim 3, wherein a binder is added to the zinc oxide loaded with copper and molybdenum compounds before shaping.

6. The method according to claim 5, wherein cement is chosen as binder.

7. The method according to claim 6, wherein after shaping the cement is cured by a steam treatment of the shaped body.

8. The method according to claim 1, wherein the mixture is adjusted to a pH in the range of from 7 to 11.

9. The method according to claim 1, wherein no ammonium hydrogen carbonate is added to the mixture.

10. The method according to claim 1, wherein the mixture is produced at a temperature of less than 50° C.

11. The method according to claim 1, wherein the mixture is produced by producing an aqueous solution of the thermally decomposable copper source as well as an aqueous solution of the thermally decomposable molybdenum source, wherein the volume of the solution of the thermally decomposable copper source and of the solution of the thermally decomposable molybdenum source corresponds to the pore volume of the zinc oxide.
